(19) United States
(12) Patent Application Publication
(10) Pub. No.: US 2006/0133596 A1
(43) Pub. Date: Jun. 22, 2006

(54) Centrex replacement ACD

(76) Inventors: Joseph C. Steinlicht, Glen Ellyn, IL (US); Don Jester, Lisle, IL (US); Jack Walsh, Naperville, IL (US)

Correspondence Address: Welsh & Katz, Ltd., 22nd Floor, 120 South Riverside Plaza, Chicago, IL, 60606, US

(21) Appl. No.: 11/005,501

(22) Filed: Dec. 6, 2004

(51) Int. Cl. H04M 3/00

(52) U.S. Cl. 379/265.02

(57) ABSTRACT

The system for connecting an incoming call to a Central Office (CO) to an agent for servicing the call, comprises: an Automatic Call Distributor (ACD) coupled to the CO; at least one agent position connected to the CO; a server computer; circuitry for connecting an incoming call via a trunk line to the Automatic Call Distributor: circuitry and software for determining at the Automatic Call Distributor which agent position(s) is available; software for advising the server computer at the Central Office to connect the incoming call to the available agent position via a bridge at the Central Office; and circuitry for disconnecting the trunk lines from the Central Office to the Automatic Call Distributor after the bridge is established so those trunk lines can be used for future calls. The method for connecting an incoming call to a Central Office to an available agent at an agent position utilizing an Automatic Call Distributor and a server computer comprising the steps of: connecting the incoming call via a trunk line to the Automatic Call Distributor; determining at the Automatic Call Distributor which agent position is available; advising the server computer to instruct the Central Office to connect the incoming call to the available agent position via a bridge at the Central Office; and disconnecting the trunk lines from the Central Office to the Automatic Call Distributor after the bridge is established so those trunk lines can be used for future calls.

### BACKGROUND

1. Field of the Invention

The present invention relates generally to customer contact handling system and more particularly to a method and system including a Central Office (CO) and an Automatic Call Distributor (ACD) for efficiently routing an incoming call to an available agent thereby to release trunk lines from a central office to the ACD.

2. Description of the Related Art

Presently, the number of trunks between the CO and the ACD are sized such that there are twice as many trunks as there were possible calls through an ACD. Alternatively, all agents are connected behind the ACD thus decreasing the number of trunks necessary.

Heretofore it has been proposed in the non-analogous field of “voice calls over a packet switched network” to process a call originator and a call terminator. The process or method includes establishing a first call-leg between the call originator and a Voice Response Unit using a menu router that provides call control services according to a signaling protocol. The method also includes establishing a second call-leg between the Voice Response Unit and the call terminator based upon the signaling protocol. The process or method further includes binding the first call-leg and the second call-leg to complete the voice call between the call originator and the call terminator, and releasing the voice call from the Voice Response Unit based upon the signaling protocol.

In a typical ACD system, selected portions of memory are assigned to agents who are logged-on to handle contacts, and selected portions of memory are assigned to circuit switched telephone trunk lines for communication with external sources. In routing a contact with an external source, the ACD establishes a relationship between a portion of memory assigned to an external line with a portion of memory assigned to an agent. In a typical ACD system, a selected portion of memory assigned to an external line is a voice port capable of interfacing with a circuit switched telephone trunk line. The number of physical telephone lines is a limitation on the number of voice ports. Heretofore it has been proposed to accomplish routing by using a “media-port” to emulate the operations of a voice port in the ACD system. The proposed system then includes allocation of memory resources, and initialization of system data in order to satisfy the operating requirements of an existing ACD system. Upon receipt of a request for a media-port from a host computer, the ACD assigns and initializes a selected portion of computer memory to appear like a voice port. The existing ACD can then function similarly for telephone and non-telephone contacts

### BRIEF SUMMARY

According to one embodiment of the present invention there is provided a system for connecting an incoming call to a Central Office (CO) to an agent for servicing the call, comprising: an Automatic Call Distributor (ACD) coupled to the CO; at least one agent position connected to the CO; a server computer; circuitry for connecting an incoming call via a trunk line to the Automatic Call Distributor: circuitry and software for determining at the Automatic Call Distributor which agent position(s) is available; software for advising the server computer at the Central Office to connect the incoming call to the available agent position via a bridge at the Central Office; and circuitry for disconnecting the trunk lines from the Central Office to the Automatic Call Distributor after the bridge is established so those trunk lines can be used for future calls.

Also, according to another embodiment of the present invention there is provided a method for connecting an incoming call to a Central Office to an available agent at an agent position utilizing an Automatic Call Distributor and a server computer comprising the steps of: connecting the incoming call via a trunk line to the Automatic Call Distributor; determining at the Automatic Call Distributor which agent position is available; advising the server computer to instruct the Central Office to connect the incoming call to the available agent position via a bridge at the Central Office; and disconnecting the trunk lines from the Central Office to the Automatic Call Distributor after the bridge is established so those trunk lines can be used for future calls.

### BRIEF DESCRIPTION OF THE SEVERAL VIEWS OF THE DRAWINGS

The invention, together with the advantages thereof, may be understood by reference to the following description in conjunction with the accompanying figure, which illustrate one embodiment of the invention.

FIG. 1 of the drawing is a diagrammatical view of one embodiment of a Central Office (CO) coupled to an Automatic Call Distributor (ACD) and shows the Central Office connected to one of a plurality of agent positions and a personal computer associated with each agent position illustrated for indicating an agent available.

### DETAILED DESCRIPTION

While the present invention is susceptible of embodiments in various forms, there is shown in the drawing and will hereinafter be described some exemplary and non-limiting embodiment(s), with the understanding that the present disclosure is to be considered an exemplification of the invention and is not intended to limit the invention to the specific embodiment(s) illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

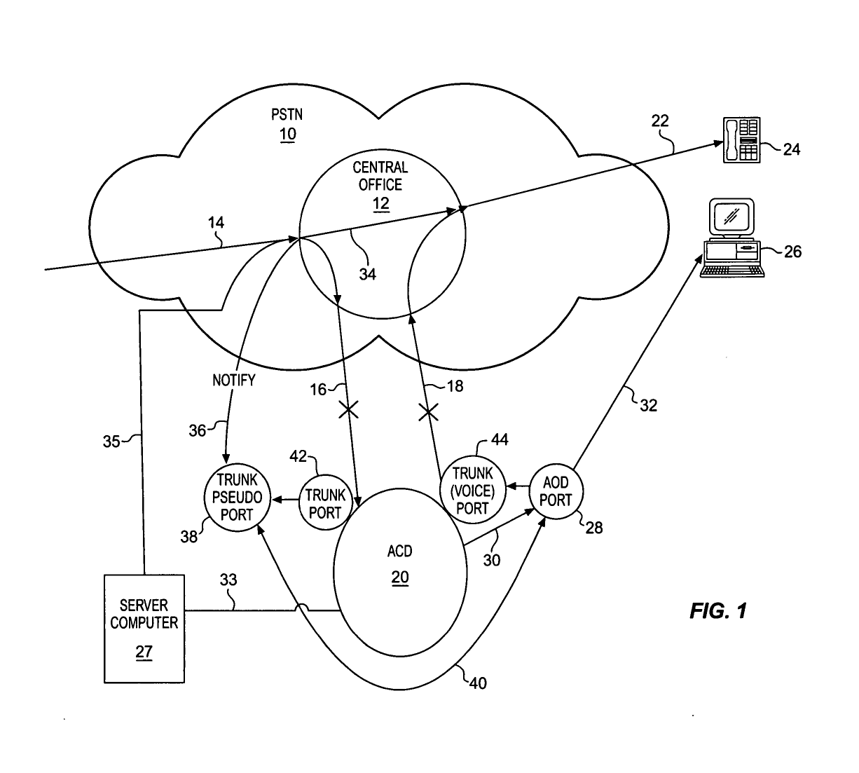

Referring now to FIG. 1, there is illustrated diagramatically therein a Public Switch Telephone Network (PSTN) 10. A Central Office (CO) 12, for a company or other entity which services callers, is connected into the PSTN 10. As shown, an incoming call would come in on an incoming line 14, to the Central Office 10. As shown, the Central Office 10 is connected by a pair of trunk lines 16 and 18 to an Automatic Call Distributor (ACD) 20. It will be understood that there are multiple pairs of trunk lines coupled from the CO 12 to the ACD 20, and only two are shown for illustrating the method and system of the illustrated embodiment.

The CO 12 is connected by an output line 22, to an agent position 24. It also will be understood that there are a plurality of output lines to a plurality of agent positions and only one is illustrated for purposes of illustration.

Now with the conventional operation of the ACD 20, which can be of the type sold under the trademark SPECTRUM by Rockwell First Point of Wood Dale, Ill., a caller calling in on input line 14, may be routed by the CO 12, over the trunk line 16 to the ACD 20. The ACD 20 would select an available agent capable of handling this type of call and establish a voice path to the agents location (if a voice path does not currently exist) by placing a call over the trunk line 18 back to the CO 12. The CO 12 may then connect the call to the output line 22, that is connected to the agent position 24 and the agent at that position will service the call. Thus by bridging the voice path within the ACD 20, between trunks 16 and 18, the agent 24 would have a voice path to/from the caller.

In this embodiment, the agent may have at his or her station or desk a Personal Computer (PC) 26, which is coupled by hardwire or wireless to a server computer 27, which can be located anywhere and is shown in FIG. 1 adjacent the ACD 20.

According to one of the teachings of the present invention, when a call comes in on input line 14 to the CO 12, the CO 12 directs the call over the trunk line 16 to the ACD 20. The ACD 20 then polls an Agent On Demand port (AOD) 28 via a line 30. The AOD port 28, is also coupled to the PC 26 via a line 32. It will be understood that a number of PC's generally equal to the number of agents may be connected to the AOD port 28, so that each agent can indicate to the AOD port, via his or her PC, agent available or agent busy. It will be noted that the AOD port 28, also functions as an Agent Pseudo Port (APP).

Returning to the scenario illustrated in the diagram, the ACD 20 may poll the AOD port 28 to learn whether the agent at position 24 is available or not.

If the agent position 24 is available, ACD 20 instructs the server computer 27, via line 33 to connect the input line 14 to the output line 22 connected to agent position 24. This connection is accomplished by the CO 12 via a bridge 34 at the CO 12. Once the bridge connection is made on bridge 34, the trunk lines 16 and 18 are disconnected so they can be available again for future calls.

The server computer 27 can be anywhere and keeps track of the time that the agent and agent position 24 is on the line servicing the caller. Then, when line 22 is disconnected by the agent hanging up agent position 24, the server computer 27, sends a signal via a line 35 and a notify line 36, to a trunk pseudo port 38, that the agent position 24 is disconnected. This disconnection or agent available is communicated via line 40, to the AOD port 28.

As shown, the trunk line 16 is associated with a Trunk Port 42 at the ACD 20 and the trunk line 18 is associated with a Trunk (Voice) Port 44 at the ACD 20.

Summarizing, in a conventional use of the ACD 20, when a call comes into the PSTN 10 and gets routed through the Central Office 12 to the ACD 20, the call will be delivered to the agent position 24 being controlled by the ACD 20. The Agent would be utilizing Agent On Demand and first must acquire a voice channel through the Central Office 12, i.e., via line 22, to an instrument, i.e., agent position 24 associated with the agent. The two trunks 16 and 18 will remain in use for the duration of the call, thus increasing the number of trunks used between the Central Office 10 and the ACD. If the trunks 16 and 18 between the Central Office 12 and the ACD 20 can employ a Release Link mechanism, then the trunks 16 and 18 can be reused for more calls.

The voice channel is connected via bridge 34 through the Central Office 12 and the control channel, from PC 26 to the server computer 27, remains being controlled by an Agent Pseudo Port/Agent On Demand port 28 (taking the place of the physical Trunk (voice) Port 44) and the Trunk Pseudo Port 42 (taking the place of the physical trunk port to the Central Office). The control of the call can remain with the ACD 20. Therefore any statistics on the call will be current even though the voice channel has been completely separated from the control channel. In addition since the Release Link (notify line 36) is used on the trunks, the savings in trunk utilization can be considerable.

Specific embodiments of novel methods for releasing trunk lines and for keeping track of time spent by each agent in answering/servicing incoming calls have been described for exemplification of the invention and are not intended to limit the invention to the specific embodiments illustrated. Numerous modifications and variations can be effectuated without deporting from the scope of the novel concepts of the invention. It is to be understood that no limitation with respect to the specific embodiment illustrated is intended or should be inferred. Accordingly, it is contemplated to cover by the appended claims any and all embodiments, modification, variations or equivalents that fall within the scope of the invention disclosed and claimed herein.

We claim:

1. A method for connecting an incoming call to a Central Office to an available agent at an agent position utilizing an Automatic Call Distributor and a server computer comprising the steps of:
connecting the incoming call via a trunk line to the Automatic Call Distributor;
determining at the Automatic Call Distributor which agent position is available;
advising the server computer to instruct the Central Office to connect the incoming call to the available agent position via a bridge at the Central Office; and,
disconnecting the trunk lines from the Central Office to the Automatic Call Distributor after the bridge is established so those trunk lines can be used for future calls.

2. The method of claim 1, including the step of monitoring the time the agent position is connected to a caller and the agent is servicing the caller and the time the call is ended, and storing the time spent by an agent servicing a caller in the server computer.

3. The method of claim 1, including the step of notifying the Automatic Call Distributor when the agent has finished the position call and updating an Agent On Demand port that the agent position for the call just completed is again open and that the agent at the agent position just released is again available to service a new call.

4. The method of claim 1 further comprising the step of establishing a connection from the Automatic Call Distributor to a personal computer associated with the agent position.

5. A system for connecting an incoming call to a Central Office (CO) to an agent for servicing the call, comprising:
an Automatic Call Distributor (ACD) coupled to the CO;
at least one agent position connected to the CO;
a server computer;
circuitry for connecting an incoming call via a trunk line to the Automatic Call Distributor:
circuitry and software for determining at the Automatic Call Distributor which agent position(s) is available;
software for advising the server computer at the Central Office to connect the incoming call to the available agent position via a bridge at the Central Office; and
circuitry for disconnecting the trunk lines from the Central Office to the Automatic Call Distributor after the bridge is established so those trunk lines can be used for future calls.

6. The system of claim 5, including circuitry and software for monitoring the time the agent position is connected to a caller and the agent is servicing the caller and the time at which the call is ended, and circuitry for storing the time spent by an agent servicing a caller in said server computer.

7. The system of claim 5, including circuitry and software for notifying the Automatic Call Distributor when the agent has finished the position call and for updating an Agent On Demand port that the agent position for the call just completed is again open and that the agent at the agent position just released is again available to service a new call.

8. The system of claim 5 further comprising circuitry for establishing a connection from the Automatic Call Distributor to a personal computer associated with the agent position.

9. Apparatus for connecting an incoming call to a Central Office (CO) to an agent for servicing the call, comprising:
an Automatic Call Distributor (ACD) coupled to the CO;
at least one agent position connected to the CO;
a server computer;
means for connecting an incoming call via a trunk line to the Automatic Call Distributor:
means for determining at the Automatic Call Distributor which agent position(s) is available;
means for advising the server computer at the Central Office to connect the incoming call to the available agent position via a bridge at the Central Office; and
means for disconnecting the trunk lines from the Central Office to the Automatic Call Distributor after the bridge is established so those trunk lines can be used for future calls.

10. The apparatus of claim 9, including means for monitoring the time the agent position is connected to a caller and the agent is servicing the caller and the time at which the call is ended, and means for storing the time spent by an agent servicing a caller in said server computer.

11. The apparatus of claim 9, including means for notifying the Automatic Call Distributor when the agent has finished the position call and for updating an Agent On Demand port that the agent position for the call just completed is again open and that the agent at the agent position just released is again available to service a new call.

12. The apparatus of claim 9 further comprising means for establishing a connection from the Automatic Call Distributor to a personal computer associated with the agent position.
